(19) United States
(12) Patent Application Publication
(10) Pub. No.: US 2011/0115794 A1
(43) Pub. Date: May 19, 2011

(54) RULE-BASED GRAPH LAYOUT DESIGN

(75) Inventors: Genady Grabarnik, Scarsdale, NY (US); Bernice E. Rogowitz, Ossining, NY (US); Larisa Shwartz, Hawthorne, NY (US)

(73) Assignee: INTERNATIONAL BUSINESS MACHINES CORPORATION, Armonk, NY (US)

(21) Appl. No.: 12/620,031

(22) Filed: Nov. 17, 2009

(51) Int. Cl. G06T 11/20

(52) U.S. Cl. 345/440

(57) ABSTRACT

A rules-based circle graph rendering system and method includes creating a first matrix representing nodes subject to graph rendering and having values representing relationships of the nodes, populating a second matrix with values representing a measure of the relationships among the nodes, and computing a third matrix by subtracting values of the first matrix from corresponding values of the second matrix. The method also includes identifying subsets of invariant indices for degrees of the third matrix, partitioning a circle with segments proportionally corresponding to the subsets of the invariant indices, and populating the circle with the nodes based on the subsets of invariant indices and connecting nodes, via edges, with other nodes identified has having the relationships. The method also includes outputting a circle graph with the populated nodes and edges.

### BACKGROUND

The present disclosure relates generally to graph layout design and, in particular, to rule-based graph layout design.

In graph design, a network is comprised of a set of nodes (entities) and edges (lines connecting the nodes). Algorithms that organize nodes and edges into a graph typically focus on minimizing the number of crossed edges and minimizing the difference in edge lengths. In simple graphs, nodes are either connected to each other or not; in more complex graphs, the strength of the connection is also represented. For example, nodes with stronger connections are typically represented by shorter edges.

A typical graph layout can be quite complex, depending upon the nature of the subject of design. This complexity can make it difficult to efficiently analyze the relationships among the nodes rendered therein, including, e.g., identification and representation of clusters.

What is needed, therefore, is a graph layout design process that provides simplified and efficient visual representations.

### BRIEF SUMMARY

Embodiments of the invention include methods for implementing rules-based graph design. The method includes creating a first matrix representing nodes subject to graph rendering and having values representing relationships of the nodes, populating a second matrix with values representing a measure of the relationships among the nodes, and computing a third matrix by subtracting values of the first matrix from corresponding values of the second matrix. The method also includes identifying subsets of invariant indices for degrees of the third matrix, partitioning a circle with segments proportionally corresponding to the subsets of the invariant indices, and populating the circle with the nodes based on the subsets of invariant indices and connecting nodes, via edges, with other nodes identified has having the relationships. The method also includes outputting a circle graph with the populated nodes and edges.

Further embodiments include a system for implementing rules-based graph design. The system includes a host system and logic executing on the host system. The logic implements a method. The method includes creating a first matrix representing nodes subject to graph rendering and having values representing relationships of the nodes, populating a second matrix with values representing a measure of the relationships among the nodes, and computing a third matrix by subtracting values of the first matrix from corresponding values of the second matrix. The method also includes identifying subsets of invariant indices for degrees of the third matrix, partitioning a circle with segments proportionally corresponding to the subsets of the invariant indices, and populating the circle with the nodes based on the subsets of invariant indices and connecting nodes, via edges, with other nodes identified has having the relationships. The method also includes outputting a circle graph with the populated nodes and edges.

Further embodiments include a computer program product for implementing rules-based graph design. The computer program product includes a computer readable storage medium having computer readable program code embodied therewith, the computer readable program code configured to implement a method. The method includes creating a first matrix representing nodes subject to graph rendering and having values representing relationships of the nodes, populating a second matrix with values representing a measure of the relationships among the nodes, and computing a third matrix by subtracting values of the first matrix from corresponding values of the second matrix. The method also includes identifying subsets of invariant indices for degrees of the third matrix, partitioning a circle with segments proportionally corresponding to the subsets of the invariant indices, and populating the circle with the nodes based on the subsets of invariant indices and connecting nodes, via edges, with other nodes identified has having the relationships. The method also includes outputting a circle graph with the populated nodes and edges.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a portion of system upon which rules-based graph design layout processes may be implemented in exemplary embodiments;

FIG. 2 a flow diagram describing a process for implementing the rules-based graph layout design in accordance with exemplary embodiments;

FIG. 3A is a diagram depicting a circle graph implemented via the rules-based graph layout design processes in accordance with exemplary embodiments; and

FIG. 3B is a diagram depicting another circle graph implemented via the rules-based graph layout design processes in accordance with exemplary embodiments.

The detailed description explains the preferred embodiments of the invention, together with advantages and features, by way of example with reference to the drawings.

### DETAILED DESCRIPTION

Methods, systems, and computer program products for implementing rules-based graph layout design are provided in exemplary embodiments. The rules-based graph layout design processes provide a framework that enables simplified and efficient visual representations of data elements and their relationships. The rules-based design processes provide a simplified first look at a design subject by sorting its nodes into a circular configuration based on node connection strength. By using a circular representation, a user can use information about the lines drawn between all connected clusters to infer information about patterns of connection. On a line, these connecting edges are not visible. The circular representation allows enhanced visualization of high-dimensional connections, since it does not stipulate two separate end points. That is, a nearby cluster may be arranged on either side of its most-connected neighbor, opening up an additional degree of freedom in cluster placement. Also, with a circular representation, there is a concept of “within” the circle, a space that may be populated with modal nodes or cluster hubs, as described further herein.

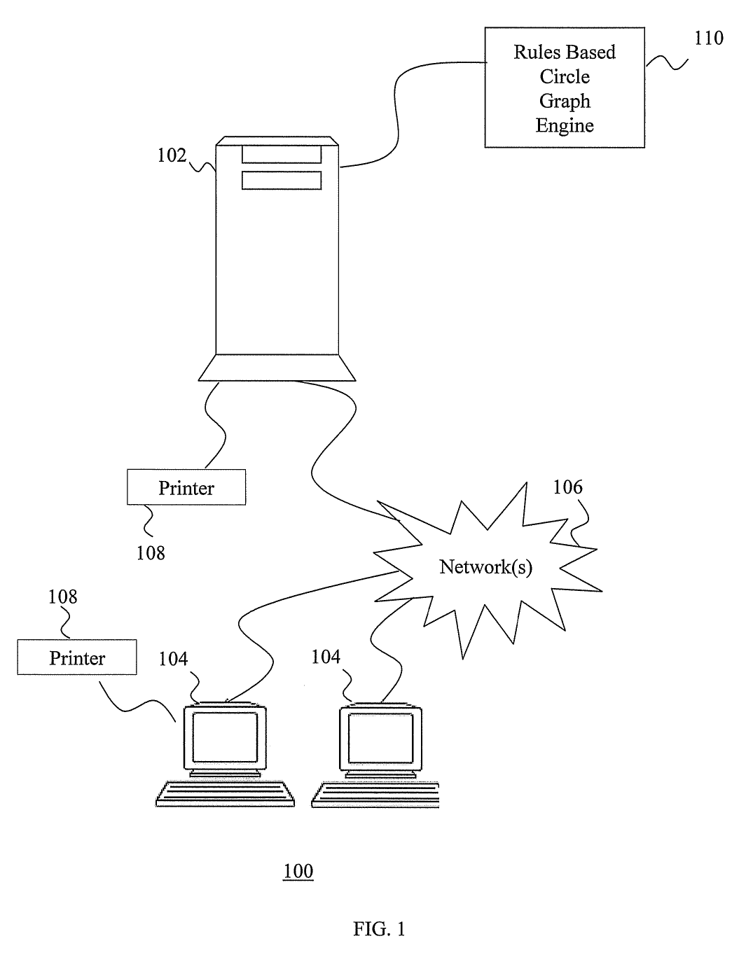

Turning now to FIG. 1, a system 100 for implementing rules-based graph layout design will now be described. In an exemplary embodiment, the system 100 includes a host system 102 executing computer instructions for performing rules-based graph layout design rendering via a rules-based circle graph engine 110 described more fully below. Host system 102 may comprise a high-speed computer processing device, such as a mainframe computer, to manage the volume of operations governed by an entity for which the rules-based circle graph engine 110 is executing. In one exemplary embodiment, the host system 102 may be part of an enterprise (e.g., a commercial business) that implements the rules-based circle graph engine 110. For example, the design subject may be a social networking website. In this example, the nodes may represent computer processing devices of members or users of the social networking website and the connections may represent the relationships among these members, as well as relationships among groups of the members. Thus, one application of the exemplary rules-based graph layout design processes includes deriving an understanding of how users in a virtual environment are connected, where their connections might be based on their social networks, and also on the type of activities performed by the users, the types of websites they visit, and/or the purchases they make.

In an exemplary embodiment, the system 100 depicted in FIG. 1 includes one or more client systems 104 through which users at one or more geographic locations may contact the host system 102. The client systems 104 are coupled to the host system 102 via one or more networks 106. Each client system 104 may be implemented using a general-purpose computer executing a computer program for carrying out the processes described herein. The client systems 104 may be personal computers (e.g., a lap top, a personal digital assistant) or host attached terminals. If the client systems 104 are personal computers, the processing described herein may be shared by a client system 104 and the host system 102 (e.g., by providing an applet to the client system 104). Client systems 104 may be operated by authorized users (e.g., programmers) of the rules-based circle graph engine 110 described herein.

The networks 106 may be any type of known network including, but not limited to, a wide area network (WAN), a local area network (LAN), a global network (e.g., Internet), a virtual private network (VPN), and an intranet. The networks 106 may be implemented using a wireless network or any kind of physical network implementation known in the art. A client system 104 may be coupled to the host system 102 through multiple networks (e.g., intranet and Internet) so that not all client systems 104 are coupled to the host system 102 through the same network. One or more of the client systems 104 and the host system 102 may be connected to the networks 106 in a wireless fashion. In one embodiment, the networks include an intranet and one or more client systems 104 execute a user interface application (e.g., a web browser) to contact the host system 102 through the networks 106. In another exemplary embodiment, the client system 104 is connected directly (i.e., not through the networks 106) to the host system 102 and the host system 102 contains memory for storing data in support of the rules-based circle graph engine 110. Alternatively, a separate storage device may be implemented for this purpose.

The host system 102 memory includes a data repository with data relating to the rules-based circle graph engine 110, as well as other data/information desired by the entity representing the host system 102 of FIG. 1. For example, the host system 102 memory may store instructions for rendering various matrices as described further herein, as well as circle graphs created via the engine 110. The host system 102 memory may be logically addressable as a consolidated data source across a distributed environment that includes networks 106. Information stored in the host system 102 memory may be retrieved and manipulated through the host system 102 and/or via the client systems 104. The data repository includes one or more databases containing, data required for rendering the circle graphs as will be described more fully below, as well as other related information.

The host system 102 depicted in the system of FIG. 1 may be implemented using one or more servers operating in response to a computer program stored in a storage medium accessible by the server. The host system 102 may operate as a network server (e.g., a web server) to communicate with the client systems 104. The host system 102 handles sending and receiving information to and from the client systems 104 and can perform associated tasks. The host system 102 may also include a firewall to prevent unauthorized access to the host system 102 and enforce any limitations on authorized access. For instance, an administrator may have access to the entire system and have authority to modify portions of the system. A firewall may be implemented using conventional hardware and/or software as is known in the art.

The host system 102 may also operate as an application server. The host system 102 executes one or more computer programs to provide rules-based circle graph rendering services. The rules-based circle graph rendering may be integrated within an existing graphical design software product. Alternatively, the rules-based circle graph rendering may be implemented independent of any particular program product, as shown, for example, in FIG. 1.

As indicated above, processing may be shared by the client systems 104 and the host system 102 by providing an application (e.g., java applet) to the client systems 104. Alternatively, the client system 104 can include a stand-alone software application for performing a portion or all of the processing described herein. As previously described, it is understood that separate servers may be utilized to implement the network server functions and the application server functions. Alternatively, the network server, the firewall, and the application server may be implemented by a single server executing computer programs to perform the requisite functions.

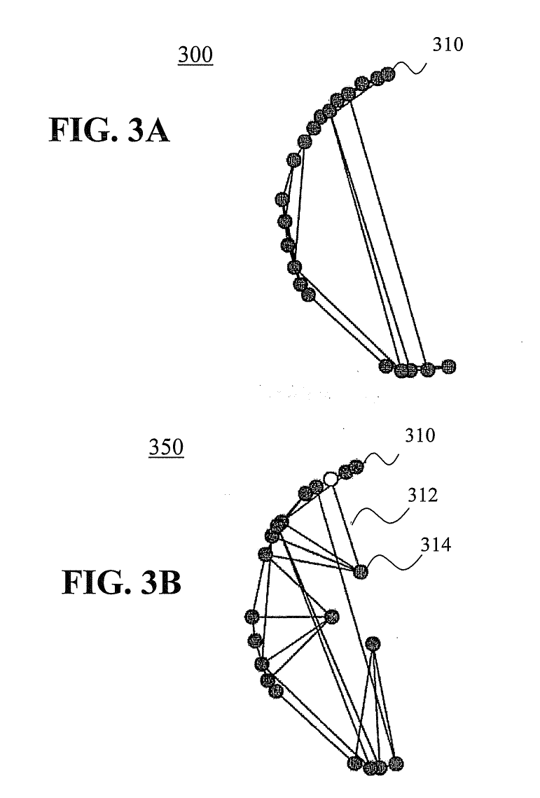

The host system 102 may also be connected to one or more printers 108 either directly (i.e., USB cable, parallel port, or other physical connection mechanism), wirelessly, or via any of the network connections described above. In addition, client systems 104 may also be connected to one or more printers 108 in the same manner as described above with regard to host system 102. The printer 108 may be any printer that is capable of transferring images into a tangible form. The client systems 104 and/or host system 102 communicate with the printer causing the printer to render a tangible image, in this case, a rules-based circle graph, a sample of which is shown in FIGS. 3A and 3B.

It will be understood that the rules-based graph layout design and rendering processes described herein may be implemented in hardware, software, or a combination thereof.

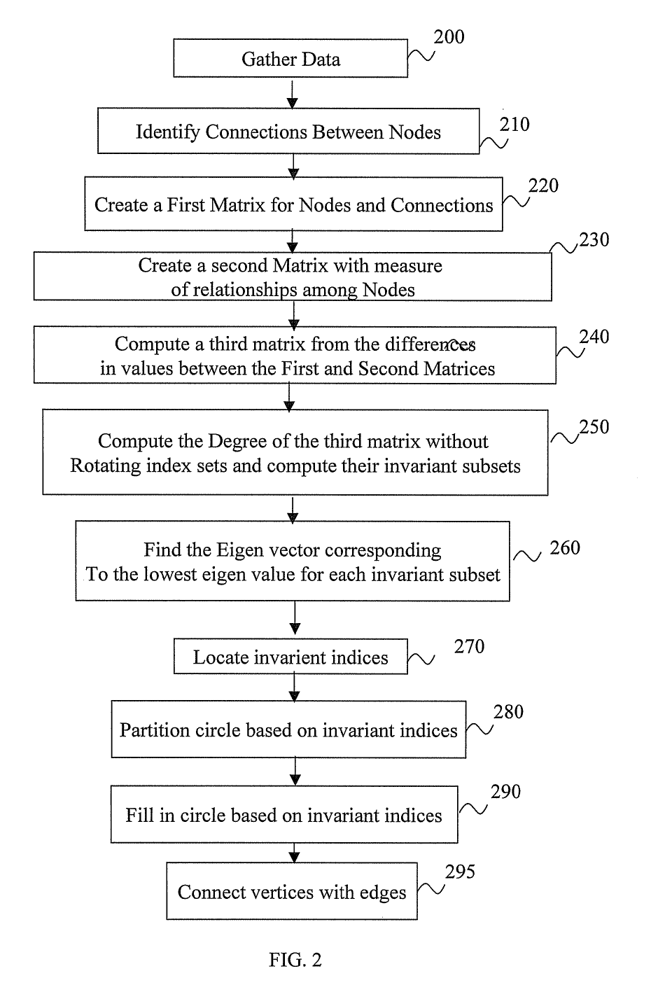

Turning now to FIGS. 2, 3A, and 3B, an exemplary graph layout design and rendering process, including resulting circle graphs will now be described. At step 200, the rules-based circle graph engine 110 retrieves data that is to be mapped on a circle graph from the host system 102 memory. The data contains information about various data elements and the connections, or relationships, between these elements. As rendered on a circle graph, the data elements represent nodes 310 (and alternatively, 314) on the graph and the connections represent edges 312 on the graph (as shown, e.g., in FIGS. 3A and 3B), and as will be described further herein. At step 210, the rules-based circle graph engine 110 analyzes the data to identify the various nodes and the edges between them (for example, nodes may identify people and links may be identified with ‘colleagues’ relationships; in another example, nodes are customers and edges are similar interests among the customers).

At step 220, the rules-based circle graph engine 110 creates a first matrix from the results of the identifications made in step 210. The first matrix may be an adjacency matrix, which is two-dimensional matrix of size n, where n is the number of nodes identified from the analysis performed in step 210. In an exemplary embodiment, the first matrix is populated with a value of ‘1’ at the intersection of two nodes if the analysis performed in step 210 indicates that the two nodes are connected, e.g., exhibit a relationship. If the analysis performed in step 210 indicates that the two nodes are not connected, a value of ‘0’ is loaded at the intersection in the first matrix of the two nodes.

At step 230, a second two-dimensional matrix of size n is created from the results of the analysis performed in step 210. The second matrix may be implemented as a degree matrix, which is a diagonal matrix whose non-zero elements lie along the matrix diagonal and the non-zero elements refer to the number of connections or edges that emanate from each node. The remaining spaces in the second matrix may be populated with zeros reflecting that no edges emanate from a particular node in the second matrix.

At step 240, a third matrix is calculated by subtracting the values in the first matrix from corresponding values in the second matrix. The third matrix may be implemented as a Laplacian matrix. The above-described matrices (adjacency, degree, and Laplacian) are well known in graph theory and will be understood by those skilled in the art. At step 250, the degree of the third matrix is calculated such that the there are no rotating index sets and the invariant subsets of these indices are calculated. This may be implemented by identifying the size of each rotating index set to find the least common multiple (LCM) and replacing the third matrix with it's power, whereby the index is equal to the LCM. These calculations are known in the field of Linear Algebra (see, for example, “Lectures on Linear Algebra,” by I. M. Gel'fand, Sep. 1, 1989, Dover Publications).

Moving on to step 260, the Eigenvector corresponding to the lowest Eigenvalue for each of the invariant subsets is calculated. The Eigenvector is a property of a matrix. For example, if a matrix is a diagonal matrix, then its eigenvalues are the numbers on the diagonal and its eigenvectors are basis vectors to which those numbers refer.

At step 270, each of the Eigenvectors from step 260 is reviewed to determine the non-decreasing Eigenvectors, and these non-decreasing Eigenvectors are selected from the group (a non-decreasing eigenvector is one having non-decreasing components). This subset of non-decreasing Eigenvectors represents the invariant indices that are used to render a rules-based circle graph as described below. Thus, the circle representation is based on the non-decreasing Eigenvectors of the third matrix described above. As a result, the rules-based circle graph engine 110 uses this information to define a proper circle ordering of the nodes, which in turn, enables it to build a circle representation of the graph defined by the third matrix.

At step 280, the rules-based circle graph engine 110 partitions a circle into segments whereby each segment is proportional to the subset of invariant indices identified in step 270. As shown in FIGS. 3A-3B, at step 290, each segment of the circle is populated with nodes 310 representing each of the invariant indices identified at step 280.

At step 295, edges 312 are rendered on the circle graph, which connect each of the nodes 310 based on the identification step 210 above. As the nodes 310 are placed on the circle of the graph 300 (or the outer circle of graph 350 as will be described more fully below) they will naturally form groupings. These groupings reflect the connections between the nodes 310. The closer the nodes 310 are to each other, the greater the number of connections there are between them. These groupings of nodes are referred to as clusters.

In one exemplary embodiment, once the steps 200-295 of FIG. 2 are completed, a circle graph (e.g., graph 300/350) is complete and may be rendered to a display. The display may be on a client system 104 (e.g., a display or monitor), or on the host system 102 or any similar device such as a handheld computer or mobile phone. Alternatively, the graph 300/350 may be rendered by a printer 108 or any other similar mechanism.

In another exemplary embodiment, a circle graph rendered by the rules-based circle graph engine 110 may contain one or more additional circles of nodes and edges. For purposes of illustration, FIG. 3B shows an example of a fully rendered circle graph 350 with nodes 310 and associated edges 312. In addition, FIG. 3B includes an inner circle populated with nodes 314. The inner circle of nodes 314 may be used to represent, for example, the most connected node in each cluster of nodes (e.g., the nodes in a cluster having the greatest degree of connection). Alternatively, the inner circle may be used to represent hubs or centroids of clusters. In either case, the inner circle may be created by shortening the circumference of the outer circle and plotting nodes (314) on the inner circle in a location parallel to the location of the associated cluster in the outer ring. Edges 312 are then drawn to connect the inner circle of nodes to the representative node 310 in the cluster of the outer circle. Although FIG. 3B illustrates a single inner circle, it will be understood that the same process described herein may be used to create any number of inner circles.

In an additional exemplary embodiment, a rules-based circle graph may be created based on the strength of the connection between nodes 310 rather than the number of connections. The steps 200-295 described above are followed, however some of the data is changed as described herein. At step 220, the first matrix is populated with values representing the relative weight of the strength of the connection between nodes 310. In addition, at step 230, the second matrix is populated with values representing the sum of the strength of the connection between nodes as opposed to the number of connections. For purposes of this example, the strength of the connection may be indicated by a number in the range of 1 and 0; however, it will be appreciated by those skilled in the art that any range of numbers may be used to indicate the strength of the connection. The remaining steps of FIG. 2 are followed as described above. The clusters of nodes 310 in the resulting rules-based circle graph (not shown) of this embodiment represent the relative strength between nodes 310 as opposed to the number of connections as described above.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that may contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, may be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that may direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A method for rules-based circle graph rendering, the method comprising:
creating a first matrix representing nodes subject to graph rendering and having values representing relationships of the nodes;
populating a second matrix with values representing a measure of the relationships among the nodes;
computing a third matrix by subtracting values of the first matrix from corresponding values of the second matrix;
identifying subsets of invariant indices for a plurality of degrees of the third matrix and partitioning a circle with segments proportionally corresponding to the subsets of the invariant indices;
populating the circle with the nodes based on the subsets of invariant indices and connecting nodes, via edges, with other nodes identified has having the relationships; and
outputting a circle graph with the populated nodes and edges.

2. The method of claim 1, wherein the first matrix is a two-dimensional matrix of size n, where n is the number of nodes in the first matrix, the method further comprising:
for each pair of nodes in the first matrix:
populating, at the intersection of a pair of nodes, a first value when it is determined that a relationship exists between the pair of nodes; and
populating, at the intersection of a pair of nodes, a second value when it is determined that no relationship exists between the pair of nodes.

3. The method of claim 1, wherein the second matrix comprises the number of edges emanating from each of the plurality nodes.

4. The method of claim 1, wherein the first matrix is populated with values representing the weight of the edges emanating from each of the nodes, and the second matrix is populated with a sum of the weights of all edges emanating from the nodes.

5. The method of claim 1, wherein the graph is rendered by printing it in a tangible form.

6. The method of claim 1, wherein the grouping of nodes form a plurality of clusters, and the circle graph contains one or more smaller inner circles; and the inner circles comprises inner nodes and inner edges; and
wherein the inner nodes represent a most connected node in each of the clusters; and
wherein the inner edges connect the inner nodes to the plurality of clusters in the outer circle closest to the inner circle.

7. The method of claim 6, wherein the inner nodes represent a hub node in each of the clusters.

8. A system for rules-based circle graph rendering, comprising:
a host system computer; and
logic executing on the host system computer, the logic implementing a method, comprising:
creating a first matrix representing nodes subject to graph rendering and having values representing relationships of the nodes;
populating a second matrix with values representing a measure of the relationships among the nodes;
computing a third matrix by subtracting values of the first matrix from corresponding values of the second matrix;
identifying subsets of invariant indices for a plurality of degrees of the third matrix and partitioning a circle with segments proportionally corresponding to the subsets of the invariant indices;
populating the circle with the nodes based on the subsets of invariant indices and connecting nodes, via edges, with other nodes identified has having the relationships; and
outputting a circle graph with the populated nodes and edges.

9. The system of claim 8, wherein the first matrix is a two-dimensional matrix of size n, where n is the number of nodes in the first matrix, the method further comprising:
for each pair of nodes in the first matrix:
populating, at the intersection of a pair of nodes, a first value when it is determined that a relationship exists between the pair of nodes; and
populating, at the intersection of a pair of nodes, a second value when it is determined that no relationship exists between the pair of nodes.

10. The system of claim 8, wherein the second matrix comprises the number of edges emanating from each of the plurality nodes.

11. The system of claim 8, wherein the first matrix is populated with values representing the weight of the edges emanating from each of the nodes, and the second matrix is populated with a sum of the weights of all edges emanating from the nodes.

12. The system of claim 8, wherein the graph is rendered by printing it in a tangible form.

13. The system of claim 8, wherein the grouping of nodes form a plurality of clusters, and the circle graph contains one or more smaller inner circles; and the inner circles comprises inner nodes and inner edges; and
wherein the inner nodes represent a most connected node in each of the clusters; and
wherein the inner edges connect the inner nodes to the plurality of clusters in the outer circle closest to the inner circle.

14. The system of claim 13, wherein the inner nodes represent a hub node in each of the clusters.

15. A computer program product for rules-based circle graph rendering, the computer program product including a computer readable storage medium having computer readable program code embodied therewith, the computer readable program code configured to implement:
creating a first matrix representing nodes subject to graph rendering and having values representing relationships of the nodes;
populating a second matrix with values representing a measure of the relationships among the nodes;
computing a third matrix by subtracting values of the first matrix from corresponding values of the second matrix;
identifying subsets of invariant indices for a plurality of degrees of the third matrix and partitioning a circle with segments proportionally corresponding to the subsets of the invariant indices;
populating the circle with the nodes based on the subsets of invariant indices and connecting nodes, via edges, with other nodes identified has having the relationships; and
outputting a circle graph with the populated nodes and edges.

16. The computer program product of claim 15, wherein the first matrix is a two-dimensional matrix of size n, where n is the number of nodes in the first matrix, the method further comprising:
for each pair of nodes in the first matrix:
populating, at the intersection of a pair of nodes, a first value when it is determined that a relationship exists between the pair of nodes; and
populating, at the intersection of a pair of nodes, a second value when it is determined that no relationship exists between the pair of nodes.

17. The computer program product of claim 15, wherein the second matrix comprises the number of edges emanating from each of the plurality nodes.

18. The computer program product of claim 15, wherein the first matrix is populated with values representing the weight of the edges emanating from each of the nodes, and the second matrix is populated with a sum of the weights of all edges emanating from the nodes.

19. The computer program product of claim 15, wherein the graph is rendered by printing it in a tangible form.

20. The computer program product of claim 1, wherein the grouping of nodes form a plurality of clusters, and the circle graph contains one or more smaller inner circles; and the inner circles comprises inner nodes and inner edges; and
wherein the inner nodes represent a most connected node in each of the clusters; and
wherein the inner edges connect the inner nodes to the plurality of clusters in the outer circle closest to the inner circle.

21. The computer program product of claim 20, wherein the inner nodes represent a hub node in each of the clusters.
